(19) United States
(12) Patent Application Publication
(10) Pub. No.: US 2023/0330832 A1
(43) Pub. Date: Oct. 19, 2023

(54) CONSTRUCTION-SITE BOX

(71) Applicant: Hilti Aktiengesellschaft, Schaan (LI)

(72) Inventors: Peter BRUGGER, Feldkirch (AT); Julia ZANONA, Feldkirch (AT)

(21) Appl. No.: 18/028,926

(22) PCT Filed: Oct. 5, 2021
(86) PCT No.: PCT/EP2021/077421

§ 371 Date: Mar. 28, 2023

(30) Foreign Application Priority Data
Oct. 9, 2020 (EP) 20200968.4

(51) Int. Cl. B25H 3/02; B25J 5/00; B25H 1/00; B25J 13/00; B25J 13/08

(52) U.S. Cl. CPC B25H 3/02; B25J 5/005; B25H 1/0035; B25J 13/003; B25J 13/08

(57) ABSTRACT

A construction site box for providing tools, power tools, power tool parts and/or consumables on a construction site, in particular on a building construction site or on a civil engineering construction site, is provided. The construction site box comprises at least one holder for holding a tool, a power tool, a power tool part and/or a consumable, a mobile transporting platform for transporting the construction site box and a motor for driving the transporting platform and enables a user of the construction site box to work on a construction site particularly efficiently and while safeguarding health.

The invention relates to a construction site box for providing tools, power tools, power tool parts and/or consumables on a construction site, in particular on a building construction site or on a civil engineering construction site.

Such a construction site box is known for example from US patent application US 2019/0154792 A1, FIG. 3.

The object of the present invention is to offer a construction site box of the type in question that enables a user of the construction site box to work particularly efficiently on a construction site.

The object is achieved by a construction site box for providing tools, power tools, power tool parts and/or consumables on a construction site, in particular on a building construction site or on a civil engineering construction site, comprising at least one holder for holding a tool, a power tool, a power tool part and/or a consumable, a mobile transporting platform for moving the construction site box and a motor for driving the transporting platform.

According to the invention, the construction site box can consequently be brought to a respective working location of a user of the construction site box by means of the mobile transporting platform and the motor in a particularly simple manner. In particular, for this purpose, the construction site box may move powered by a motor.

Consequently, the construction site box can be brought into a range of the user particularly easily and quickly, so that the user can effortlessly change necessary power tools, power tool parts and/or tools without wasting time, or only very little time, and/or can obtain a required consumable, thereby enabling the user to work particularly efficiently on the construction site.

The holder may take the form of a compartment or a rest. Preferably, the construction site box has more than one holder. Experience shows that activities to be performed on construction sites often comprise at least two tasks. For example, fitting a screwed anchor in a ceiling generally requires the task of drilling a borehole and the task of screwing the screwed anchor into the borehole. Particularly preferably, the construction site box therefore has at least three rests, allowing at least one power tool and at least two tools, for example a drill bit and a screw bit, to be provided.

The at least one holder may be designed for holding power tool parts, such as for example rechargeable batteries. Tools, in particular for power tools, for example drill bits, chisels or saw blades, and consumables such as anchors, dowels or the like, can likewise be held in at least one of the holders. It is also conceivable that the construction site box has a holder for holding a measuring instrument and/or a measuring utensil.

The transporting platform may take the form of a track-chain undercarriage and/or comprise such an undercarriage. Alternatively or additionally, the transporting platform may also be a wheeled undercarriage or a mobile, multi-leg frame and comprise such an undercarriage or frame. Safe movement within a construction site is thereby made possible. The construction site box can even be moved over uneven ground, as often to be expected on a construction site.

In the case of a particularly preferred class of embodiments of the construction site box, the transporting platform is formed such that it can move in a remotely controllable, partly autonomous and/or autonomous manner. For this purpose, it may comprise a remote control, for example a wireless remote control, such as for example a radio remote control, an infrared and/or a WLAN remote control, or other wireless or wired-bound remote control.

An autonomously movable transporting platform may be understood as meaning a transporting platform which can move to an intended location within the construction site without running into other objects or persons without needing movement control and/or supervision by the user. It may in particular be designed to choose automatically the intended location, the time of starting the movement and/or its movement path to the intended location. A partly autonomously transportable transporting platform may be understood as meaning a transporting platform which can move within the construction site, in particular without running into other objects or persons, but needs at least restricted movement control and/or supervision by a user, for example in the form of monitoring and, as and when required, braking or starting-up by the user.

It is also conceivable that the construction site box is designed for automatically tracking the user. In particular, the construction site box may be capable of operating in a tracking operating mode. For this purpose, it may be designed to bring itself automatically into the proximity of the user, even when the user goes to a different location on the construction site. Elements kept in the construction site box can therefore always be available and ready to hand to the user.

It is also conceivable that the construction site box has at least one, in particular rechargeable, energy store. It is preferably an electrical energy store. The energy store may for example be a lithium-based rechargeable battery. The energy store may be designed for self-sufficiency and/or for supplying other devices. It may be dimensioned in such a way that uninterrupted operation of the construction site box, preferably including external devices connected to it, is possible over a time period of at least 3 h, particularly preferably of at least 6 h.

Particularly preferably, the construction site box has a power connection for the connection of external devices, for example handheld power tools such as power drills, chisel tools or hammer drills. Consequently, a connection point to a local power supply system is no longer required for supplying energy to these external devices.

If the construction site box has at least one charging station for charging an external energy store, for example a rechargeable battery of a cordless handheld power tool or the like, the battery and a replacement battery can be used with the handheld power tool alternately, while the other one is being charged in the construction site box. Consequently, the handheld power tool can be used almost uninterruptedly on the construction site, even over a relatively long time.

Preferably, the construction site box has at least one computer unit and/or a display unit. The computer unit may be a tower PC and/or a portable computer unit. The display unit may be a monitor and/or a portable display unit. For example, the display unit may be part of the portable computer unit, for example of a tablet computer. It is conceivable in particular that the construction site box has a number of computer units and/or a number of display units.

The construction site box may be designed as a communication center. For this purpose, it may have at least one wireless communication interface. The wireless communication interface may for example comprise a WLAN, cellular and/or Bluetooth interface and/or other wireless interface. Particularly preferably, the wireless communication interface has a router and/or can be operated as a router. It may in particular be designed for communication with a cloud-based computer unit.

To enable the user of the construction site box to have direct access to planning data associated with the construction site, it is advantageous if the construction site box is designed to receive Building Information Modeling (BIM) data via the communication interface, to store such data and/or to provide such data via the communication interface. For this purpose, the communication interface may be designed to build up a communication link with a remote computer system, in particular a computer cloud, for data exchange.

The construction site box may also have at least one position and/or location detection unit.

Consequently, together with the BIM data, the user can be shown on the display unit which tasks are to be performed in the area of the location where the user and/or the construction site box is in each case.

A particularly wide range of tasks can be efficiently performed by means of the construction site box if the construction site box has at least one controllable manipulator. The manipulator can as a result also contribute to safeguarding the health of the user. The manipulator may be formed for work on ceilings, walls and/or floors, generally places that are difficult for the user to access. For this purpose, it may have at least two, preferably at least four, controllable axes. Preferably, the manipulator can be supplied with energy by the energy store.

The controllable manipulator preferably has an end effector at its free end. The end effector may be equipped with a vibration damper. The vibration damper may be designed to isolate vibrations occurring on the end effector, for example due to a power tool arranged on the end effector, from the rest of the controllable manipulator. This allows effects of wear on the controllable manipulator to be reduced or avoided entirely.

The manipulator is preferably controllable by means of the computer unit. In a way comparable to the transporting platform, the manipulator may be formed such that it works in a partly autonomous or autonomous manner. It is conceivable that the manipulator is controllable on the basis of the BIM data.

The manipulator may be designed to perform one or more tasks in dependence on its position and/or its location, in particular detected by the position and/or location detection unit, and/or in dependence on the stored BIM data. The task may be for example that of drilling one or more boreholes.

Since experience shows that often a number of tasks have to be performed at one location on a building site, there is consequently the possibility that the manipulator undertakes some of the tasks, for example in dependence on the tools available on the end effector, whereas the user performs some other of the tasks manually by means of the further power tools, tools and/or consumables taken along in the construction site box. Thus, the manipulator may autonomously, i.e. automatically, drill one or more boreholes in a ceiling. The user can then mount a ceiling element, for example of a large surface area, on the ceiling by means of a number of anchors stored in the construction site box and by means of a battery-operated screwdriver kept in the construction site box. A rechargeable battery required for the battery-operated screwdriver may for this purpose have been charged in advance by means of the charging station.

It is advantageous in this respect that all of the required devices and parts are within the range of the user directly on the spot. This also obviates the need for incidental activities that are otherwise required, for example clearing away a tool, a conventional construction site box or the like, in order to get to the place of work at all. This also produces an increase in efficiency.

In order to increase a working range of the manipulator, the construction site box may also have a lifting device. The lifting device may be designed to displace the manipulator along a vertical, in particular in order to set a height position of the manipulator.

To improve the safety of the user, it may be that movements of the construction site box, the manipulator and/or the lifting device can be limited in dependence on a position and/or an inclination of the construction site box, the manipulator and/or the lifting device. For example, operation of the manipulator may be disabled if the construction site box is inclined by more than 15° with respect to the vertical.

Preferably, the manipulator is designed as a collaborative manipulation arm. For this purpose, there may be contact sensors arranged along the manipulator, by which the movement of the manipulator is stopped as soon as undesired contact of the manipulator with a nearby object or a person, for example the user, is detected. Alternatively or additionally, such functionality may also be realized by a sensor system installed in the manipulator together with a suitably formed control unit.

It is also conceivable that the manipulator takes the form of an xy, z or xyz manipulator unit. For example, the manipulator may take the form of a vertically and/or horizontally adjustable power-drill guiding unit.

The working area in which for example a task is performed with a power tool arranged on the end effector can be monitored if the construction site box has at least one optical recording device, for example a time-of-flight camera. The optical recording device may be designed to record a three-dimensional image of the working area and/or its surrounding area. The computer unit may be designed to process the image recorded by the optical recording device. The display unit may be designed to show the recorded image and/or a processed result.

A cleaner working result can be achieved easily, and therefore efficiently, by the construction site box having a suction device. It may also have a blowing-out device, for example for cleaning a borehole. The suction device and the blowing-out device may be formed together in one device.

The suction device and/or the blowing-out device may likewise be supplied with energy by the energy store.

A suction line may be arranged on the manipulator. The suction line may be able to be connected or be connected to the suction device and/or to the blowing-out device. A suction-extraction adapter may be arranged on the end effector or on a power tool arranged on the end effector. Preferably, the suction-extraction adapter is connected or at least able to be connected to the suction line. The suction line in turn may be connected or at least able to be coupled at its other end to the suction device. Consequently, dust can be extracted from the area of the power tool fitted in the end effector and directed by way of the suction line to the suction device.

The suction device and/or the blowing-out device may also be formed as removable from the construction site box. There may also be a holder provided for them within the construction site box.

In the case of one class of embodiment of the invention, the construction site box has at least one compressor, a paint container and/or a spray nozzle. The spray nozzle may preferably be arranged in the region of the end effector. It may then be used for marking places of work or for differentiating and/or grouping the places of work, for example of boreholes produced. For this purpose, it may be that, by means of the spray nozzle together with the compressor and the paint container, paint can be sprayed for example onto the place of work.

The compressor may be a compressed-air compressor. It may be that the compressed air can be directed to the manipulator. For this purpose, a compressed-air hose may run along the manipulator. Then, the power tool arranged on the end effector can be designed to be pneumatically actuated. This makes it possible to use with the manipulator commercially available power tools that are not specifically designed for operation on a manipulator, for example handheld power tools.

Consequently, the user can also easily use a handheld power tool in an area that he could not otherwise readily reach, in particular not without further aids. For example, work with the handheld power tool on a ceiling is made much easier.

If the construction site box, in particular the transporting platform and/or the manipulator, is controllable by at least one acoustic and/or optical signal, for example a voice command or an optically detectable gesture of the user, the user can control the construction site box, for example move the manipulator and/or give it a task and/or transport the construction site box, without having to interrupt his current activity.

For example, this enables the user to hold a ceiling element or the like in position with both hands and to use a voice command and/or a gesture to make the construction site box, in particular the manipulator, perform work on the ceiling element held or pre-positioned by the user. For example, the manipulator may drill one or more boreholes into the ceiling element and/or insert one or more anchors, for example screws, into the ceiling element or through the ceiling element and screw them to the ceiling.

It is also conceivable that the construction site box is designed for detecting the point of origin of the acoustic and/or optical signal. Consequently, the construction site box may be designed to move itself into the vicinity of the user as soon as the user calls the construction site box or gives it a corresponding sign.

It is also conceivable that the construction site box has a collision avoidance unit. For this purpose, it may have at least one distance sensor. The distance sensor may be designed to detect whether the construction site box maneuvers itself into the vicinity of an object. The construction site box may be designed for this case to stop and/or to alter a planned further path of movement.

It is also conceivable that the construction site box has a housing. The housing may be lockable, for example able to be locked up. This allows valuable items that are held in the holders of the construction site box to be protected from theft or the like.

Further features and advantages of the invention emerge from the following detailed description of exemplary embodiments of the invention, with reference to the figures of the drawing, which shows details essential to the invention, and from the claims. The features shown there are not necessarily to be understood as true to scale and are shown in such a way that the special features according to the invention can be made clearly visible. The various features can be implemented individually in their own right or collectively in any combination in variants of the invention.

In the schematic drawing, exemplary embodiments of the invention are shown and explained in more detail in the following description.

In the figures:

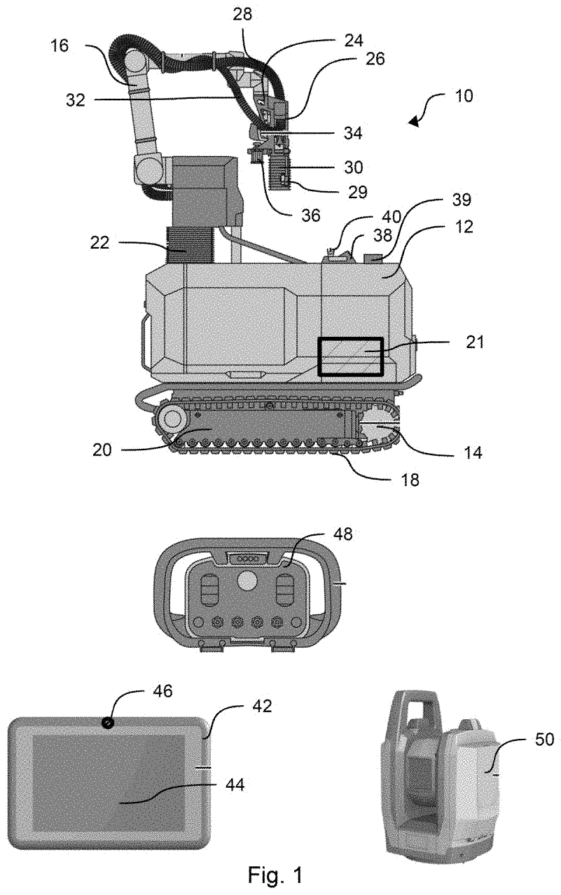

FIG. 1 shows a side view of a construction site box and views of further details of the construction site box;

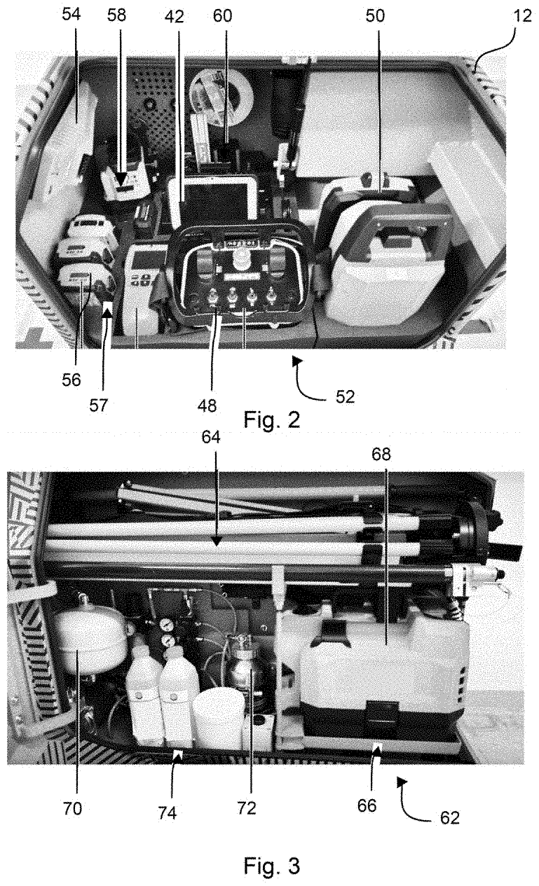

FIG. 2 shows a charging station of the construction site box;

FIG. 3 shows a lateral stowage space of the construction site box;

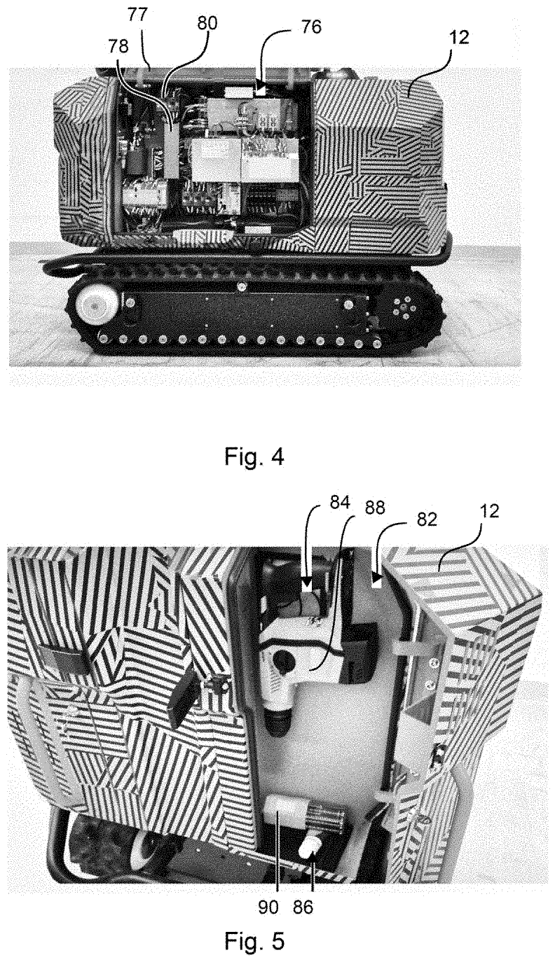

FIG. 4 shows a control space of the construction site box and

FIG. 5 shows a further stowage space of the construction site box.

In order to make it easier to understand the invention, the same reference signs are used in each case for identical or functionally corresponding elements in the following description of the figures.

FIG. 1 shows a side view of a construction site box 10. As will be explained in more detail below, the construction site box 10 is designed for providing tools, power tools, power tool parts and consumables on a construction site, for example on a building construction site or on a civil engineering construction site.

The construction site box 10 comprises a housing 12, on the underside of which a mobile transporting platform 14 is arranged. On the upper side of the housing 12 there is a manipulator 16.

The mobile transporting platform 14 takes the form of a track-chain undercarriage. For this purpose, two chains, of which only one chain 18 can be seen in the side view according to FIG. 1, can be driven by a motor 20 for driving the transporting platform 14.

The motor 20 can be supplied with electrical energy by an energy store 21 formed as a lithium-based rechargeable battery. The energy store 21 is arranged inside the housing 12, and therefore is only schematically represented in FIG. 1.

The manipulator 16 is arranged on the housing 12 by way of a lifting device 22. The lifting device 22 is designed to set a height position of the manipulator 16, and thereby increase the maximum range of the manipulator 16.

An end effector 24 is formed at the free end of the manipulator 16. Arranged on the end effector 24, by way of a power tool fitting, is a power tool 26, in this case an electrical handheld power tool formed as a power drill.

A suction line 28 together with a suction adapter 30 can be used to extract dust, drilling dust or the like from the working area of the power tool 26.

Also arranged on the end effector 24 is a marking unit, in particular in the form of a spray nozzle 29, with which paint can be sprayed, for example to produce colored markings.

Arranged to the side of the power tool 26 is an optical recording device 34. The optical recording device 34 has a time-of-flight camera, so that a three-dimensional image of the working area of the power tool 26 and its surrounding area can be captured.

A position mark 36 is also arranged in the region of the end effector 24. The position mark 36 takes the form of a polyhedral reflective surface, to interact with a position-and-location detection unit still to be described in more detail below.

Also arranged on the upper side of the housing 12 is a state-of-charge display unit 38 for displaying the available remaining energy of the energy store 21.

Along with the state-of-charge display unit 38, an emergency-off switch 40 is provided, with which the construction site box 10, and any connected devices, can be switched off at short notice if need be.

Also arranged on the housing 12 is a docking station 39, which is formed for receiving a tablet computer 42. The tablet computer 42 is shown in FIG. 1 as one of a number of individual parts in a separate front view. It has in particular a computer unit, with which a display unit 44 can be activated. The tablet computer 42 is also equipped inter alia with a microphone 46 for recording voice signals or the like.

In the lower region of FIG. 1, a radio remote control 48 can also be seen, with which the transporting platform 14 can be remotely controlled. It offers the possibility of controlling each of the chains 18 independently of one another, so that the transporting platform 14 formed as a track-chain undercarriage can be controlled to move forward, backward, to the left, to the right or, in particular by controlling the chains 18 so as to run in opposite directions, to turn on the spot.

FIG. 1 shows as a further individual part of the construction site box 10 a position-and-location detection unit 50 in the form of an automatic total station in a perspective view from obliquely above.

The position-and-location detection unit 50 is designed to interact with the position mark 36 in order to determine both the position of the construction site box 10 and also its relative location or alignment in relation to a predefined coordinate system, for example by markers arranged in a distributed manner on the construction site. Since the position mark 36 is arranged in the region of the end effector 24, it is possible to determine both the position and the alignment or location of the end effector 24, and consequently the power tool 26 fitted in it.

FIG. 2 shows a charging station 52 of the construction site box 10 (FIG. 1). The charging station 52 is formed in a rear region of the construction site box 10. The charging station 52 is inside the housing 12. In order to be able to reach the charging station 52, the housing 12 has a housing cover which can be swung open, which cannot be seen in FIG. 2.

The charging station 52 has a charger 54, with which external energy stores, in particular rechargeable batteries 56, can be charged. The rechargeable batteries 56, only one of which is provided with a reference sign as being representative, represent replacement batteries. Until they are possibly used at a later time, they are therefore kept in each case in battery holders 57, one of which once again is provided with a reference sign as being representative.

For optimized use of the space, further holders are formed in the region of the charging station 52, for example a line-laser holder 58 and also a range-finder holder 60, in which correspondingly a line laser and a range finder are respectively held.

The tablet computer 42, the radio remote control 48 and the position-and-location detection unit 50 may also be kept in corresponding holders in the charging station 52.

FIG. 3 shows a side compartment 62 of the construction site box 10 (FIG. 1). In particular, a measuring-utensil holder 64 can be seen, in which measuring utensils associated with the position-and-location detection unit 50, for example a measuring rod for separate determination of positions on a construction site, are held.

A suction device 68 is also held in a suction device holder 64. The suction device 68 is removable from the construction site box 10, so that it can also be used independently of the construction site box 10. It is able to be connected to the suction line 28 (FIG. 1).

A compressor 70, which takes the form of a compressed-air compressor and, together with a paint container 72, provides the spray nozzle 29 (FIG. 1) with paint, can also be seen.

Also provided is a consumables holder 74, in which various service materials and/or consumables, for example paint and/or thinner, can be stored.

FIG. 4 shows a control space 76 of the construction site box 10 (FIG. 1), which is located in the interior of the housing 12 behind a housing cover 77, which in FIG. 4 has been swung open and is only partially visible.

The control space 76 has a computer unit 78, taking the form of a tower PC. The computer unit 78 is connected to a communication interface 80. The communication interface 80 has a cellular receiver and also a WLAN interface. The communication interface 80 is in particular designed to be operated as a router. For this purpose, it is designed to transfer data between the cellular interface the WLAN interface. It is also designed to establish network connections with the tablet computer 42 (FIG. 1) and also possibly with further devices, for example a further construction site box.

Finally, FIG. 5 shows a side compartment 82 of the construction site box 10, which is likewise located in the interior of the housing 12 and behind a housing cover which can be swung open, which cannot be seen in FIG. 5.

Formed in the side compartment 82 is a power-tool holder 84 and also a tool holder 86.

Arranged in the power-tool holder 84 is a power tool 88 formed as a handheld power tool, for example as a hammer drill, for which tools 90, in particular rock drills, are fitted in the tool holder 86.

It is also conceivable that a holder for consumables such as screwed anchors or the like is formed, for example outside the housing 12, it being possible that the consumables are removable, preferably with the end effector 24 or a consumable gripping device located on it, for further processing.

### LIST OF REFERENCE SIGNS

10 Construction site box
12 Housing
14 Transporting platform
16 Manipulator
18 Chain
20 Motor
21 Energy store
22 Lifting device
24 End effector
26 Power tool
28 Suction line
29 Spray nozzle
30 Suction adapter
32 Compressed-air hose
34 Optical recording device
36 Position mark
38 Charging station display unit
39 Docking station
40 Emergency-off switch
42 Tablet computer
44 Display unit
46 Microphone
48 Radio remote control
50 Position-and-location detection unit
52 Charging station
54 Charger
56 Rechargeable battery
57 Battery holder
58 Line-laser holder
60 Range-finder holder
62 Side compartment
64 Measuring-utensils holder
66 Suction-device holder
68 Suction device
70 Compressor
72 Paint container
74 Consumables holder
76 Control space
77 Housing cover
78 Computer unit
80 Communication interface
82 Side compartment
84 Power-tool holder
86 Tool holder
88 Power tool
90 Tool

1. A construction site box for providing tools, power tools, power tool parts and/or consumables on a construction site, comprising
at least one holder for holding a tool, a power tool, a power tool part and/or a consumable,
a mobile transporting platform for moving the construction site box and
a motor for driving the mobile transporting platform.

2. The construction site box as claimed in claim 1, wherein the transporting platform takes a form of a track-chain undercarriage and/or comprises a track-chain undercarriage.

3. The construction site box as claimed in claim 1, wherein the mobile transporting platform is formed such that the mobile transporting platform can move in a remotely controllable, partly autonomous, and/or autonomous manner.

4. The construction site box as claimed in claim 1, wherein the construction site box has at least one rechargeable, rechargeable energy store.

5. The construction site box as claimed in claim 1, wherein the construction site box has at least one charging station for charging an external energy store.

6. The construction site box as claimed in claim 1, wherein the construction site box has at least one computer unit and/or a display unit.

7. The construction site box as claimed in claim 1, wherein the construction site box has at least one wireless communication interface.

8. The construction site box as claimed in claim 1, wherein the construction site box is designed to receive Building Information Modeling (BIM) data via the communication interface, to store BIM data and/or to provide BIM data via the communication interface.

9. The construction site box as claimed in claim 1, wherein the construction site box has at least one position-and/or-location detection unit.

10. The construction site box as claimed in claim 1, wherein the construction site box has at least one controllable manipulator.

11. The construction site box as claimed in claim 1, wherein the construction site box has at least one optical recording device.

12. The construction site box as claimed in claim 1, wherein the construction site box has a suction device and/or a blowing-out device.

13. The construction site box as claimed in claim 1, wherein the construction site box has at least one compressor, a paint container and/or a spray nozzle.

14. The construction site box as claimed in claim 1, wherein the construction site box, is controllable by at least one acoustic and/or optical signal.

15. The construction site box as claimed in claim 4, wherein the construction site box has at least one rechargeable energy store.

16. The construction site box as claimed in claim 11, wherein the at least one optical recording devices comprises a time-of-flight camera.

17. The construction site box as claimed in claim 14, comprising a controllable manipulator wherein the mobile transporting platform and/or the controllable manipulator are controllable by at least one acoustic and/or optical signal.

18. The construction site box of claim 14, wherein the at least one acoustic and/or optical signal comprises a voice command or an optically detectable gesture of a user.

19. The construction site box as claimed in claim 1, further comprising a controllable manipulator on an upper side of the construction site box.

20. The construction site box as claimed in claim 1, wherein the construction site box has at least one space behind a housing cover that can be swung open.
